(19) United States
(12) Patent Application Publication
(10) Pub. No.: US 2020/0401955 A1
(43) Pub. Date: Dec. 24, 2020

(54) SYSTEMS AND METHODS FOR AUTOMATED ITINERARY MODIFICATION

(71) Applicant: Verint Americas Inc., Alpharetta, GA (US)

(72) Inventors: Fred A. Brown, Colbert, WA (US); Linda Lou Beloberzycky, Mead, WA (US)

(21) Appl. No.: 16/919,761

(22) Filed: Jul. 2, 2020

Related U.S. Application Data
(63) Continuation of application No. 13/429,131, filed on Mar. 23, 2012, now abandoned.
(60) Provisional application No. 61/467,442, filed on Mar. 25, 2011.

(51) Int. Cl. G06Q 10/02; G06Q 10/10

(52) U.S. Cl. CPC G06Q 10/02; G06Q 10/10

(57) ABSTRACT

Systems and methods are disclosed which allow for changes to be made to an existing order using an automated system. A user may interact with an automated agent using any communication modality that generally emulates an interaction with a human customer service representative. Should the interaction exceed a predefined level of complexity, or meet other criteria, the user may be routed to a human customer service representative.

### RELATED APPLICATIONS

This application claims priority U.S. Provisional Patent Application No. 61/467,442 entitled “SYSTEMS AND METHODS FOR AUTOMATED ITINERARY MODIFICATION” filed on Mar. 25, 2011 which is incorporated by reference herein in its entirety.

### BACKGROUND

Airlines and travel agencies sometimes experience large call volumes associated with customer-initiated changes to reservations and bookings. Handling this high volume of calls is relatively expensive due to the high cost of labor associated with Customer Service Representatives (CSRs). Typically, when a traveler wants to make a change to their travel reservation, they contact a CSR via telephone to initiate a conversation with the CSR. Through a conversation with the traveler, the CSR may determine the traveler's intent (i.e. to make a change to a reservation or ticket) and obtain identifying information (e.g. traveler's name, record locator) from the traveler. The CSR then searches for and retrieves the traveler's passenger name record (“PNR”) from a computer reservation system. Based on the traveler's intent, the CSR may, for example, search for a new flight, look at availability on the new flight, check the fare code, and determine any price changes. The CSR may then ask for traveler's permission to make the change and, if granted permission, make the change to the PNR. If the traveler does not want to travel on the new flight, the CSR must repeat the process by searching through the available flights again to hopefully locate a flight that accommodates the traveler's needs.

### SUMMARY

In one general aspect, the present invention is directed to a computer-based systems and methods for changing an existing order for a user. In various embodiments, a user with an existing order, such as a travel itinerary, may contact and interact with a computer-based autonomous intelligent agent. The autonomous intelligent agent may employ natural language dialog processing to determine from an input of the user the desired order change. The autonomous intelligent agent, hereafter “automated agent,” may be implemented as a computer-based entity programmed to respond to inputs in a predetermined fashion that may mimic a human consciousness. Depending on, for example, the complexity of the existing order, the complexity of the requested order change, and/or the confidence level in understanding the user's requested change, the system may determine an available alternative to the order based on the user's requested order change. The alternative can be communicated to and, if acceptable, selected by, the user. The system can then update the user's order based on the acceptance of the alternative.

Such system may be beneficial in the travel industry for travelers to make changes to existing itineraries without necessarily having to contact a human CSR agent. These and other benefits are described below.

### BRIEF DESCRIPTION OF THE DRAWINGS

The present disclosure will be more readily understood from a detailed description of some example embodiments taken in conjunction with the following figures, wherein:

FIG. 1 illustrates an example computer-based itinerary modification system in accordance with one non-limiting embodiment.

FIG. 2 is a schematic illustration of an itinerary modification system 200 in accordance with one non-limiting embodiment.

FIG. 3 illustrates a process flow 300 of an itinerary modification system in accordance with one non-limiting embodiment.

### DETAILED DESCRIPTION

Various non-limiting embodiments of the present disclosure will now be described to provide an overall understanding of the principles of the structure, function, and use of the itinerary modification systems and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The presently disclosed example embodiments are generally directed to systems and methods for utilizing automated natural language understanding to allow a user to change or otherwise modify an electronically stored itinerary, order, schedule, agenda, or the like, through the user's interaction with an automated agent. For the sake of clarity, the present disclosures will be described mainly in the context of a traveler making a change to their travel itinerary, although this disclosure is not so limited. The presently disclosed systems and methods may be used in a wide variety of contexts and applications without departing from the scope of this disclosure. For example, the systems and methods may also be used in the shipping industry for modifying an order or shipment or goods through a user's interaction with an automated agent or in the financial industry to assist a user creating or interacting with a financial account. Furthermore, while the travel-based embodiments are presented herein largely in the context of airline travel, this disclosure is not so limited. The disclosed systems and methods may be used in a variety of travel-based implementations, such modifying arrangements associated with buses, trains, cruise ships, hotels, resorts, or rental cars, for example, or a combination of two or more arrangements (e.g., changing flight, hotel, and rental car reservations during a single interaction with the system). In any event, the systems and methods generally allow a user to interact with an automated system to change a previously established activity or status such as a schedule, an itinerary, a routing of a shipment, a funds transfer, an order, or the like without necessarily interacting with a human CSR. The automated system may be associated with an airline, a travel agency, a website, a shipping company, a governmental entity, an enterprise's internal travel department, a rental car company, a bank, a credit card issuer, or any other entity associated with activities, accounts, events, etc. of a user.

For the purposes of the application, the terms “customer,” “traveler,” and “user” may be used interchangeably and refer to an individual or group that participates in the processes or systems disclosed below of purchasing or obtaining travel arrangements and then making changes to the original itinerary. The term “provider” or “seller” refers to any individual, group, partnership, corporation, company, agency, or other entity that provides travel services.

As described in more detail below, when a user engages the presently disclosed systems and methods, an automated agent may be presented to the user in any suitable format, such as a automated agent on a web site with a text interface, a automated agent application on a mobile device, or a speech recognition interface over a phone line, for example. In some embodiments, the automated agent comprises a natural language dialog system that interacts with the user. A natural language dialog system is generally an automated system that is intended to engage a human in a conversation (using any of several modalities of human language) for the purpose of helping the human achieve some goal. Often times a single input from a user does not contain sufficient information to allow an automated system to provide a meaningful response. In such cases, the natural language dialog system may engage the user in a dialog to prompt the user to provide more information. This “back and forth” between the automated system and the user continues until the system has collected sufficient information to allow it to provide a meaningful response.

The presently disclosed systems and methods may utilize any suitable natural language dialog systems, such as the natural language dialog systems described in U.S. Pat. Nos. 7,565,368; 7,603,705; and 7,908,274, each of which is incorporated by reference in its entirety. The automated agent may be based on the ACTIVE AGENT™ solution from Next IT Corporation, Spokane, Wash., or some other suitable autonomous computer-based intelligent agent. Additional information regarding intelligent agents may be found in Stuart Russell and Peter Norvig, “Artificial Intelligence: A Modern Approach,” Prentice-Hall, Inc., Chap. 2, “Intelligent Agents,” pp. 31-52 (1995), the entirety of which is incorporated by reference.

In the travel industry, a Passenger Name Record (PNR) is a file typically contained within a database of a Computer Reservation System (CRS). This file contains the details of a traveler's itinerary. When a traveler books an itinerary with an airline or travel agency, a Master PNR is typically created. The Master PNR may be identified in the computer reservation system using a unique alpha-numeric “record locator.” When portions of the traveler's itinerary are provided by airlines other than the one that created the Master PNR, a copy of the Master PNR is created and sent to the other airlines. Those airlines will typically create a copy of the PNR for their own systems, and assign their own record locators. These record locators will be sent back to the holder of the Master PNR so that all of the PNRs can be linked together. If a traveler wishes to change travel details (i.e., flight times, destination or departure city, airline, etc.), a change must be made to the traveler's PNR.

In accordance with the presently disclosed embodiments a traveler may interact with an automated agent that generally emulates an interaction with a human CSR in order to change travel plans. The automated agent and the traveler may engage in a natural language dialog in order for the automated agent to collect similar information that a human CSR would need to locate and access a PNR. The automated agent may gather, for example, the traveler's name, travel confirmation number, departure cite, arrival city, and/or other relevant information. The automated agent may also gather information regarding the traveler's request, such as a change in the traveler's itinerary for example, such as a new departure time or a new arrival time in some embodiments, as discussed in more detail below, one or more computer modules may be used to access a PNR from a backend computer reservation system (using the record locator), and then extract the information contained in the PNR. The automated agent may then search for flights satisfying the traveler's revised itinerary criteria and present choices to the traveler. Rules specific to each ravel company may be applied by the system in order to arrive at a correct price for a desired change. The rules for pricing a change are typically complicated and specific to each travel company. The presently disclosed embodiments allows for the application of company-specific business rules.

In some embodiments the traveler's desired changes may be too complicated for the automated agent to efficiently or accurately make the changes to the traveler's itinerary. In such situations, once it is determined by the system that the complexity of the desired changes is above a complexity threshold, the traveler may be connected with a human CSR to assist with the travel modifications. Furthermore, even if the desired changes are relatively simple, the PNR may be relatively complicated. In such situations, once it is determined by the system that the complexity of the PNR is above a threshold, the traveler may be connected with a human CSR to assist with the travel modifications.

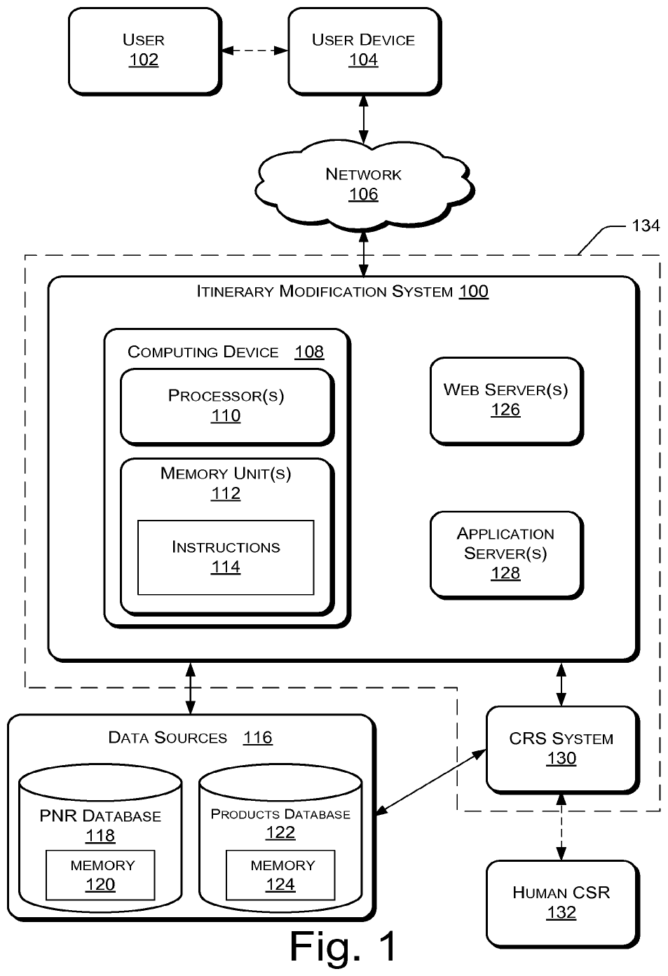

Referring now to FIG. 1, one example embodiment of the present disclosure may comprise a computer-based itinerary modification system 100 that is configured to interact with a user 102 through a user device 104 associated with user 102. The user 102 may be, for example, a traveler who wants to make a change to a travel itinerary. It is noted that the term “change” is used herein to represent any modification to the travel itinerary from the traveler's point of view. In other words, the traveler may be changing their itinerary even through there is not a corresponding change to the PNR associated with that traveler. Additionally, a change in a traveler's itinerary may result in the creation of a new PNR. In many instances, the traveler need not even be aware that there is a PNR associated with their travel arrangements, nor need to know how the PNR was particularly altered in response to their modification request. In industries other than travel the “change” can include modifications from the user's perspective without necessarily exposing underlying records or data structures to the user 102. The user 102 may engage the itinerary modification system via any of several possible communication channels (e.g. web, network-enabled mobile device, landline phone, mobile phone, VoIP, etc.). The itinerary modification system 100 and the user 102 may enter into a conversation, where the conversation involves some form of natural human communication (e.g. written or spoken) over the chosen channel between the user and an automated agent.

The itinerary modification system 100 may be in communication with the user device 104 via an electronic communications network 106. The communications network 106 may include a number of voice, computer and/or data networks, including the Internet, LANs, WANs, GPRS networks, peer-to-peer networks, ad-hoc networks, mesh networks, etc., and may comprise wired and/or wireless communication links. The user device 104 may communicate with the itinerary modification system 100 and the user device 104 may be any type of client device suitable for communication over the network 104, such as a land line telephone, a mobile telephone, a VoIP telephone, a personal computer, a laptop computer, a netbook computer, a tablet computer, etc. for example. In some example embodiments, the user 102 may communicate with the network 106 via a user device 104 that is a combination handheld computer and mobile telephone, sometimes referred to as a smart phone. It can be appreciated that while certain embodiments may be described with users communication via a mobile phone, smart phone, or laptop by way of example, the communication may be implemented using other types of user equipment (UE) or wireless computing devices such as a mobile telephone, personal digital assistant (PDA), combination mobile telephone/PDA, handheld device, mobile unit, subscriber station, game device, set-top box, messaging device, media player, pager, or other suitable mobile communications devices. Additionally, while a single user device 104 is illustrated, it is to be appreciated that the itinerary modification system 100 may support simultaneous communication with a plurality of user devices 104. For example, in some implementations, the itinerary modification system 100 may be configured to simultaneously communicate with a hundred or more separate user devices 104.

The user device 104 may provide a variety of applications for allowing the user 102 to accomplish one or more specific tasks using the itinerary modification system 100. Applications may include, without limitation, a web browser application (e.g., INTERNET EXPLORER, MOZILLA, FIREFOX, SAFARI, OPERA, NETSCAPE NAVIGATOR), telephone application (e.g., cellular, VoIP, PTT), networking application, messaging application (e.g., e-mail, IM, SMS, MMS, BLACKBERRY Messenger), contacts application, calendar application, and so forth. The user device 104 may comprise various software programs such as system programs and applications to provide computing capabilities in accordance with the described embodiments. System programs may include, without limitation, an operating system (OS), device drivers, programming tools, utility programs, software libraries, application programming interfaces (APIs), and so forth. Exemplary operating systems may include, for example, a PALM OS, MICROSOFT OS, APPLE OS, UNIX OS, LINUX OS, SYMBIAN OS, EMBEDIX OS, Binary Run-time Environment for Wireless (BREW) OS, JavaOS, a Wireless Application Protocol (WAP) OS, and others. While the itinerary modification system 100 may be configured to interact with software-based user devices 104, the user device 104 does not necessarily need to utilize applications and/or operating systems. For example, in some embodiments, the user 102 may interact with the itinerary modification system 100 using voice commands conveyed to the itinerary modification system 100 using a standard landline or a relatively primitive mobile telephone. The present disclosure is not limited to any particular type of user device 104.

Still referring to FIG. 1, the itinerary modification system 100 may be provided using any suitable processor-based device or system, such as a personal computer, laptop, server, mainframe, or a collection (e.g., network) of such computing devices, for example. The itinerary modification system 100 may comprise a computing device 108 that may include one or more processors 110 and one or more computer memory units 112. For convenience, only one processor 110 and only one memory unit 112 are shown in FIG. 1. The processor(s) 110 may execute software instructions 114 stored in the memory unit 112. The processor(s) 110 may be implemented as an integrated circuit (IC) having one or multiple cores. The memory unit(s) 112 may include volatile and/or non-volatile memory units. Volatile memory units may include random access memory (RAM), for example. Non-volatile memory units may include read only memory (ROM), for example, as well as mechanical non-volatile memory systems, such as, for example, a hard disk drive, an optical disk drive, etc. The RAM and/or ROM memory units may be implemented as discrete memory ICs, for example.

When the processor(s) 110 of the itinerary modification system 100 executes the instructions 114, the processor(s) 110 may be caused to perform the various operations of the itinerary modification system 100, such as communicate with the user 102, locate an order (e.g., PNR) associated with the user 102, and change the order, as discussed in more detail below. Data used by the itinerary modification system 100 may be from various data sources 116, such as a PNR database 118, which may be an electronic computer database, for example, that stores travel-related data. The data stored in the PNR database 118 may be stored in a non-volatile computer memory 120, such as a hard disk drive, a read only memory (e.g., a ROM IC), or other types of non-volatile memory. Data may also be stored in a products database 122, which may be an electronic computer database, for example, that stores data about airline flights, rental cars, hotels, trains, boats, etc. The data stored in the products database 122 may be stored in a non-volatile computer memory 124, such as a hard disk drive, a read only memory (e.g., a ROM IC), or other types of non-volatile memory. As is to be appreciated, the PNR database 118 and the products database 122 may each be a collection of multiple databases, which may be located in remote locations and in networked communication.

As shown in FIG. 1, the itinerary modification system 100 may include several computer servers. For example, the itinerary modification system 100 may include one or more web servers 126 and application servers 128. For convenience, only one web server 126 and one application server 126 are shown in FIG. 1, although it should be recognized that the invention is not so limited. The web server 126 may provide a web user interface through which users of the system may interact with the itinerary modification system 100. The web server(s) 126 may accept requests, such as HTTP requests, from the user 102 (such as via web browsers on a user device 104), and serve the user 102 responses, such as HTTP responses, along with optional data content, such as web pages (e.g., HTML documents) and linked objects (such as images, etc.). The application server(s) 128 may provide a user interface for users who do not communicate with the itinerary modification system 100 using a web browser. Such users may have special software installed on their user devices 104 that allow the users to communicate with the application server(s) 128 via the network 106. Such software may be downloaded, for example, from the itinerary modification system 100, or other software application provider, over the network 106 to such user devices 104. The software may also be installed on such user devices 104 by other means known in the art, such as CD-ROM, etc. The servers 126 and 128 may comprise processors (e.g., CPUs), memory units (e.g., RAM, ROM), non-volatile storage systems (e.g., hard disk drive systems), etc. either located at a single location or distributed across multiple locations. The servers 126 and 128 may utilize operating systems, such as Solaris, Linux, or Windows Server operating systems, for example.

In general, an application may provide a user interface to communicate information between the itinerary modification system 100 and the users 102 via user devices 104. The user devices 104 may include various components for interacting with the application such as a display for presenting the user interface and a keypad for inputting data and/or commands. The user devices 104 may include other components for use with one or more applications such as a stylus, a touch-sensitive screen, keys (e.g., input keys, preset and programmable hot keys), buttons (e.g., action buttons, a multidirectional navigation button, preset and programmable shortcut buttons), switches, a microphone, speakers, an audio headset, a camera, and so forth. Through the interface, the users 102 may interact with the itinerary modification system 100. The applications may include or be implemented as executable computer program instructions stored on computer-readable storage media such as volatile or non-volatile memory capable of being retrieved and executed by a processor to provide operations for the user devices 104. The memory may also store various databases and/or other types of data structures (e.g., arrays, files, tables, records) for storing data for use by the processor and/or other elements of the user devices 104.

In addition to the end user devices 104, the itinerary modification system 100 may be in communication with other entities, such as a customer service representative (CSR) system 130, for example. The CSR system 130 may be associated with a human CSR 132. In some embodiments, the itinerary modification system 100 is integrated into the CSR system 130, which is schematically illustrated as integral system 134. The CSR system 130 may also be in communication with the various data sources 116, such as the PNR database 118 and the products database 122.

Although FIG. 1 depicts a limited number of elements for purposes of illustration, it can be appreciated that the itinerary modification system 100 may include more or less elements as well as other types of elements in accordance with the described example embodiments. Elements of the itinerary modification system 100 may include physical or logical entities for communicating information implemented as hardware components (e.g., computing devices, processors, logic devices), executable computer program instructions (e.g., firmware, software) to be executed by various hardware components, or combination thereof, as desired for a given set of design parameters or performance constraints.

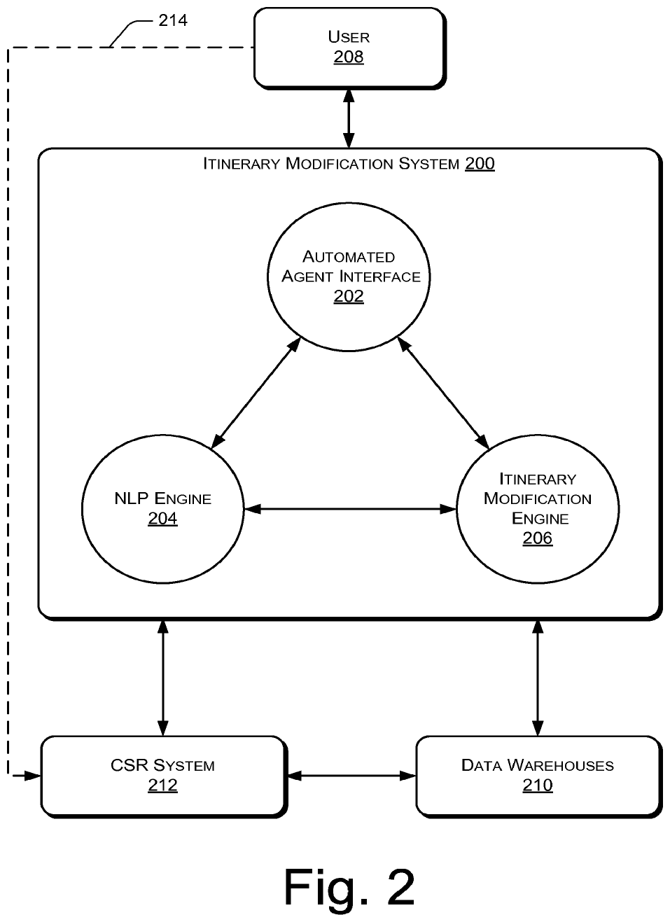

FIG. 2 is a schematic illustration of an itinerary modification system 200 in accordance with one non-limiting embodiment. The itinerary modification system 200 may comprise a plurality of components, engines, or modules, such as an automated interface agent 202, a natural language processing (NLP) engine 204, and an itinerary modification engine 206. As illustrated, the interface agent 202, the natural language processing engine 204, and the itinerary modification engine 206 may be in communication. The itinerary modification system 200 may be configured to interact with a user 208 via any suitable communications protocol. The itinerary modification system 200 may also be coupled to various data warehouses 210 and at least one customer service representative system 212. In some embodiments the data warehouses 210 include both local and remote databases. In some embodiments, the itinerary medication system 200 is a component of the customer service representative system 212.

When the user 208 first contacts the itinerary modification system 200, the user 208 may interact with the automated agent interface 202. In some embodiments the user 208 may initiate contact with the itinerary modification system 200 via a telephone call, for example. In other embodiments, the customer service representative system 212 (or other type of system) may route the user 208 to the itinerary modification system 200. With the assistance of the natural language processing engine 204, the automated agent interface 202 may generally emulate interaction with a “live” customer service representative. To those ends, through communication with the user 208, the automated agent interface 202 may determine the user's identity and intent (e.g., change an itinerary, cancel an itinerary, etc.). The itinerary modification system 200 may gather various types of information via a natural language dialog with the user 208. In the case of changing a travel itinerary, the gathered information may include information such as, without limitation, a record locator number, flight number(s), dates of travel, desired modifications, and the like. Once the goal of the user 208 has been determined, the itinerary modification engine 206 may communicate with various data warehouses 210 and interact with various back-end travel-booking systems (i.e., “shopping engines”) to determine what options are available to meet the goal of the user 208. For example, the itinerary modification engine 206 may ascertain flight availability, seating availability, flight costs, flight times, and/or flight durations. It is noted that the data obtained by the itinerary modification engine 206 is not necessarily limited to the original carrier, as the itinerary modification system 200 may search across multiple carriers.

Since changing an itinerary may result in additional financial charges to the traveler, the itinerary modification engine 206 may automatically calculate the cost to the user 208 to change the itinerary. The cost to the user 208 may be calculated using any suitable technique. In one embodiment, the cost for the user 208 is determined by subtracting the remaining value of the unused portion of the booked ticket from the new charges associated with the change. The itinerary modification system 200 may attempt to determine this remaining value by using natural language processing (NLP) to read the PNR and extract the value (if any) of the unused portion of the ticket. In some cases, depending on the type of change to the itinerary and/or other business rules, the remaining value may not be permitted to be applied towards the cost of the new ticket, especially if the new ticket is with a different carrier. In that case, the itinerary modification system 200 may request that a credit for this amount be held with the previous carrier. New charges associated with the change may include a variety of charges or costs such as the cost of the new flight, surcharges, luggage fees, premium seat fees, and/or any other additional charges, for example.

The automated agent interface 202 may convey the various options and pricing ramifications to the user 208. For example, the automated agent interface 202 may identify potential alternative flights to the user 208 and a cost associated with changing to each one. In some embodiments, the options are first retrieved and presented to the user 208 and after a selection by the user 208 of a particular option is the pricing ramification determined. In any event, the user 208 may choose to accept one of the proposed options through interaction with the automated agent interface 202. Once approval has been received, the itinerary modification system 200 may make any necessary changes to the user's PNR. If payment from the user 208 is required, it may be accepted using any suitable technique known in the art. If the user 208 rejects the proposed options, the user 208 may simply maintain their previous travel arrangements.

In various embodiments, the user 208 interacting with the itinerary modification system 200 may be routed (as indicated by pathway 214 in FIG. 2) to a human customer service representative associated with the CRS system 212 if certain conditions are met. For example, if the user 208 has been interacting with the automated customer service for more than a predetermined amount of time, the user 208 may be automatically routed to a human customer service representative. Similarly, if certain words or phrases are uttered by the user during the course of interaction with the automated customer service representative, the user 208 may be routed to a human customer service representative to continue the interaction. Should the user 208 be transferred to a human customer service representative, some or all of the information gathered from the user 208 by the itinerary modification system 200 may be provided to the human customer service representative. For example, a graphical user interface associated with the human customer service representative may automatically display the user's name along with other information gleaned from the interaction between the user 208 and the automated agent interface 202.

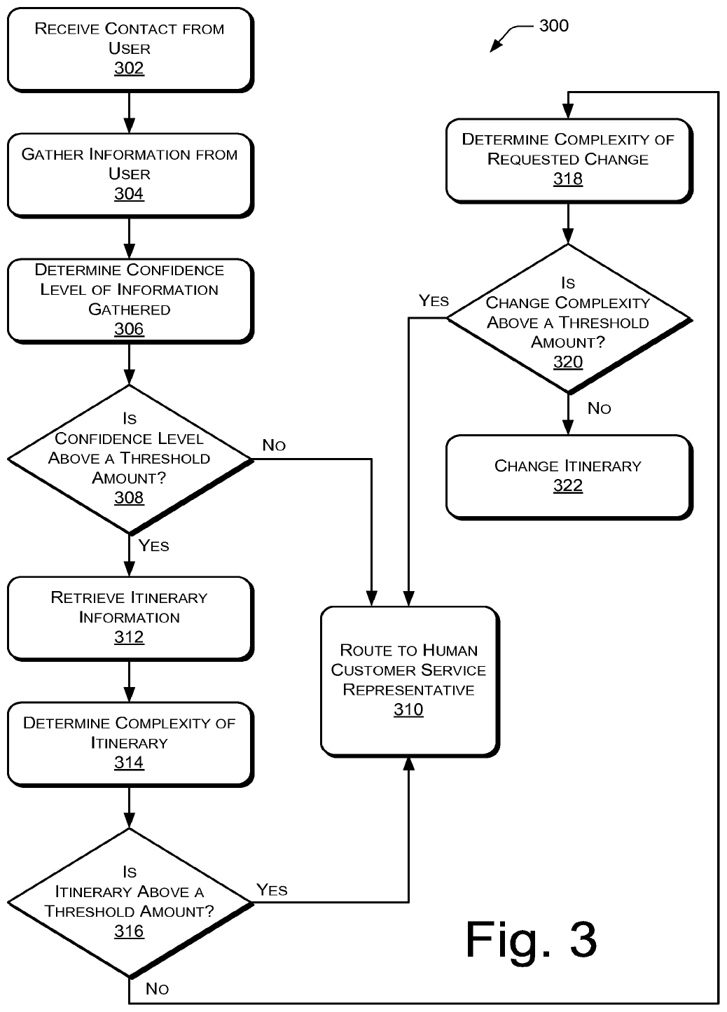

FIG. 3 illustrates a process flow 300 of the itinerary modification system 100 in accordance with one non-limiting embodiment that is based on a series of complexity thresholds. Referring to FIGS. 1 and 3, at 302, contact is received by the itinerary modification system 100 from a user. At 304, information is gathered from the user. The information may be gathered via the user's interaction with an automated agent utilizing natural language processing to interpret inputs from the user, for example. In some embodiments, the user may interface with the system using a text-based interface (e.g., via a web browser or application). In other embodiments, the user may interface with the system via a voice connection (e.g., landline connection, mobile connection, VoIP connection). At 306, a confidence level in the information gathered at 304 is determined by the itinerary modification system 100. The confidence level may be determined using any technique known in the art. At 308, it is determined if the confidence level in the information gathered from the user is above a confidence threshold amount. The confidence threshold amount may be a predetermined threshold or the threshold may be determined essentially in real time while gathering information from the user.

If the confidence level is not at or above the threshold, at 310 the user may be routed to a human customer service representative. At that point, the human customer service representative can continue the conversation with the user and assist with the modification of the user's travel itinerary.

If the confidence level is determined to be above the threshold at 308, then at 312, the itinerary modification system 100 may retrieve itinerary information (e.g., PNRs) associated with the user based on the information gathered from the user at 304. Once the itinerary information is retrieved, at 314, the itinerary modification system 100 may parse the itinerary information to determine a complexity level. The complexity level of the itinerary information may be determined using any suitable technique, such as the number of different carriers associated with the file, the number of legs to the trip, the destination or departure cities, or a variety of other factors. The factors may be predetermined and may be based on a category of the information (e.g., a travel itinerary may be associated with different factors than a package shipping request).

At 316, it is determined if the complexity level of the itinerary information retrieved at 312 is above a complexity threshold amount. If the complexity level is above the threshold, the user may be routed to a human customer service representative to handle the user's request at 310. If the complexity level is at or below the threshold, at 318, the itinerary modification system 100 may next determine the complexity of the requested change. At 320, it is determined if the complexity level in the requested change is above a complexity threshold amount. If the complexity level is above the threshold, the user may be routed to a human customer service representative at 310. If the complexity level is at or below the threshold, at 322, the itinerary modification system 100 may change the itinerary in accordance with the requested change. As is to be appreciated, the change to the itinerary at 322 may include presenting options to the user, determining pricing ramifications for the various options, and making the change in response to agreement from the user.

### CONCLUSION

In general, it will be apparent to one of ordinary skill in the art that at least some of the embodiments described herein may be implemented in many different embodiments of software, firmware, and/or hardware. The software and firmware code may be executed by a processor or any other similar computing device. The software code or specialized control hardware that may be used to implement embodiments is not limiting. For example, embodiments described herein may be implemented in computer software using any suitable computer software language type, using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device such as, for example, a computer system (non-volatile) memory, an optical disk, magnetic tape, or magnetic disk. Furthermore, at least some of the processes may be programmed when the computer system is manufactured or stored on various types of computer-readable media.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include other types of non-transitory memory storage that is physical, virtual, permanent, temporary, Semi-permanent, and/or semi-temporary.

A “computer,” “computer system,” “host,” “server,” or “processor” may be, for example and without limitation, a processor, microcomputer, minicomputer, server, mainframe, laptop, tablet computer, personal data assistant (PDA), wireless e-mail device, cellular phone, smart phone, pager, processor, fax machine, scanner, or any other programmable device configured to transmit and/or receive data over a network. Computer systems and computer-based devices disclosed herein may include memory for storing certain software modules used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm” or other grouping of networked servers (such as server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability. Servers described herein may also include distributed computing devices in which multiple processors and/or memory components are located in physically separate locations to create a networked or cloud-based computing system.

The computer systems may comprise one or more processors in communication with memory (e.g., RAM or ROM) via one or more data buses. The data buses may carry electrical signals between the processor(s) and the memory. The processor and the memory may comprise electrical circuits that conduct electrical current. Charge states of various components of the circuits, such as solid state transistors of the processor(s) and/or memory circuit(s), may change during operation of the circuits.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a computer, a firmware element embedded in hardware, or any combination thereof.

Reference throughout the specification to “various embodiments,” “some embodiments,” “one embodiment,” “some example embodiments,” “one example embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

1.-9. (canceled)

10. One or more computer-readable storage media storing computer-readable instructions that, when executed, instruct one or more processors to perform operations comprising:
causing a conversation user interface of an automated agent to be presented on a display of a computing device to enable a conversation between the automated agent and a user;
receiving multiple natural language inputs from the user through the conversation user interface during the conversation;
performing natural language processing with the multiple natural language inputs to determine information for identifying an existing order associated with the user;
retrieving at least one order file associated with the existing order for the user based at least in part on the information for identifying the existing order;
obtaining input of the user regarding modification of the existing order;
determining that a complexity level of the modification of the existing order is above a threshold; and
causing the user to be connected with a customer service representative in response to determining that the complexity level of the modification of the existing order is above the threshold;
determining at least one alternative for the existing order based at least in part on the input of the user regarding modification of the existing order;
causing the at least one alternative to be presented to the user;
obtaining input of the user that indicates approval of the at least one alternative;
upon obtaining the input of the user, modifying the at least one order file based at least in part on the at least one alternative.

11. The one or more computer-readable storage media of claim 10, wherein the conversation user interface is configured to receive input from the user through multiple modalities.

12. The one or more computer-readable storage media of claim 10, wherein causing the conversation user interface to be presented comprises causing the conversation user interface to be displayed on a web site.

13. The one or more computer-readable storage media of claim 10, wherein the at least one order file comprises a passenger name record that includes details of a travel itinerary.

14. The one or more computer-readable storage media of claim 10, wherein the information for identifying the existing order comprises at least one of a name, a travel confirmation number, a departure city or an arrival city.

15. The one or more computer-readable storage media of claim 10, wherein the input of the user regarding the modification of the existing order is received through the conversation user interface.

16. The one or more computer-readable storage media of claim 10, wherein the operations further comprise:
upon retrieving the at least one order file associated with the existing order, determining that the at least one order file is associated with a complexity level above a threshold; and
causing the user to be connected to a customer service representative to carry out the modification of the existing order.

17. A method comprising:
under control of one or more computing devices,
causing a conversation user interface of an automated agent to be output via a display of the one or more computing devices to enable a conversation between the automated agent and a user, the automated agent emulating human interaction;
collecting information from multiple natural language inputs that are received from the user through the conversation user interface during the conversation, the information indicating a request to modify an existing order associated with the user;
determining that a key phrase is contained in one or more of the natural language inputs;
causing the conversation user to be connected with a customer service representative in response to determining that the key phrase was contained in one or more of the natural language inputs;
determining at least one alternative for the existing order based at least in part on the information;
causing the at least one alternative to be output to the user through the conversation user interface of the automated agent;
obtaining input of the user through the conversation user interface, the input of the user providing approval of the at least one alternative; and
upon obtaining the input of the user, modifying the existing order based at least in part on the at least one alternative.

18. The method of claim 17, wherein causing the conversation user interface to be output comprises causing the conversation user interface to be displayed on a web site.

19. The method of claim 17, wherein the conversation user interface is configured to receive input from the user through multiple modalities.

20. The method of claim 17, wherein the existing order comprises a travel itinerary of the user.

21. The method of claim 17, further comprising:
upon obtaining the multiple natural language inputs of the user, determining that a complexity level of the modification of the existing order is above a threshold; and
causing the user to be connected to a customer service representative.

22. A computing device comprising:
one or more processors;
memory communicatively coupled to the one or more processors and storing instructions that, when executed, cause the one or more processors to perform operations comprising:
outputting a conversation user interface of an automated agent to a user to enable a conversation between the automated agent and the user;
receiving multiple natural language inputs from the user through the conversation user interface, the multiple natural language inputs requesting modification of an existing order associated with the user;
retrieving at least one order file associated with the existing order based at least in part on the multiple natural language inputs requesting modification of the existing order associated with the user;
upon retrieving the at least one order file associated with the existing order, determining that the at least one order file is associated with a complexity level above a threshold;
causing the user to be connected to a customer service representative to carry out the modification of the existing order;
providing to the customer service representative information gathered from the user, the at least one order file, or a combination thereof;
identifying at least one alternative for the existing order based at least in part on the multiple natural language inputs of the user;
outputting the at least one alternative to the user through the conversation user interface of the automated agent;
receiving input from the user that provides approval of the at least one alternative;
upon receiving the input from the user, causing the existing order to be modified based at least in part on the at least one alternative.

23. The computing device of claim 22, wherein at least one of the multiple natural language inputs comprises speech input.

24. The computing device of claim 22, wherein the existing order comprises a travel itinerary of the user.

25. The computing device of claim 22, wherein the computing device comprises at least one of a smart phone or a tablet computer.

26. The computing device of claim 22, further comprising:
a display to output the conversation user interface to the user.

27. The computing device of claim 22, wherein the operations further comprise:
upon receiving the multiple natural language inputs from the user, determining that a complexity level of the modification of the existing order is above a threshold; and
causing the user to be connected to a customer service representative.
